(19) United States
(12) Patent Application Publication
(10) Pub. No.: US 2026/0134340 A1
(43) Pub. Date: May 14, 2026

(54) USING NOISE IN MEMRISTORS FOR DIFFERENTIAL PRIVACY

(71) Applicant: Hewlett Packard Enterprise Development LP, Spring, TX (US)

(72) Inventors: Aditya Dhakal, Santa Clarita, CA (US); Giacomo Pedretti, San Francisco, CA (US); Pavana Prakash, Folsom, CA (US); Kaiwen Cao, Urbana, IL (US); Sai Rahul Chalamalasetti, Pleasanton, CA (US); Archit Gajjar, Timnath, CO (US)

(21) Appl. No.: 18/947,821

(22) Filed: Nov. 14, 2024

(51) Int. Cl. G06N 20/00; G06F 21/62

(52) U.S. Cl. CPC G06N 20/00; G06F 21/6218

(57) ABSTRACT

In certain examples, a method may include receiving a privacy parameter and selecting an electrical property range for cells in a crossbar array based on the privacy parameter. The cells in the crossbar array may then be programmed based on the selected electrical property range, which may provide a certain level of differential privacy.

### BACKGROUND

Machine learning and artificial intelligence process and analyze increasingly large amounts of data. Therefore, concerns about privacy and data protection have grown. Approaches to data privacy often involve trade-offs between utility and protection, potentially reducing the effectiveness of machine learning models or compromising sensitive information.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example computing system, according to some implementations;

FIG. 2 illustrates an example crossbar array, according to some implementations;

FIG. 3 illustrates an example differential privacy accelerator, according to some implementations;

FIG. 4 illustrates an example acceleration system, according to some implementations; and

FIG. 5 illustrates an example acceleration method, according to some implementations.

### DESCRIPTION

Differential privacy provides a framework for preserving individual privacy while allowing meaningful data analysis. This approach adds calibrated noise to data or computations, making it difficult to extract information about specific individual data while substantially maintaining the overall statistical properties of the dataset. Thus, as an example, differential privacy may seek to ensure that the inclusion or exclusion of a single individual's data in a dataset does not significantly change results obtained by analyzing the dataset, which may reduce the ability of a hypothetical attacker to derive information about any individual whose data is included in the dataset. However, implementing differential privacy can be computationally intensive, especially when applied to large-scale machine learning models or real-time data processing systems.

Hardware acceleration may be used to improve the performance and efficiency of machine learning tasks. Various specialized hardware components, such as graphics processing units and tensor processing units, may speed up neural network computations. However, these accelerators are typically not designed for sampling probability distributions, which can make it difficult to effectively satisfy the requirements of differential privacy.

Analog computing systems, including those based on memristive devices, may be used for energy-efficient and high-performance machine learning acceleration. These systems may use the physical properties of materials and devices to perform computations, exhibiting inherent variability and noise. Such inherent characteristics can be effectively used for privacy-preserving computations.

In some implementations, differential privacy in machine learning may be implemented using crossbar arrays (e.g., memristor crossbar arrays) which may be controlled, at least in part, by a noise selection component. The crossbar array may have a plurality of cells, e.g., memristor cells, each including one or more memristors. Memristor devices are a type of non-volatile memory that may exhibit intrinsic stochastic behavior via inherent variability of memristor conductances relative to conductance values programmed to the memristors. This behavior can be used to implement differential privacy efficiently.

As an example, the system may use the intrinsic stochastic behavior of memristor devices to add noise to the data before it is released to the public. By tuning the conductance values used to program the memristor crossbar array, the level of noise, and thus privacy, can be controlled by, e.g., the noise selection component. This allows differential privacy to be achieved with a relatively small computational overhead attributed to satisfying the differential privacy requirements.

The system may receive a desired level of privacy as an input parameter (e.g., a privacy parameter) and map the desired privacy parameter to corresponding electrical property ranges (e.g., memristor conductance ranges) that produce an appropriate level of noise. The system may further program a memristor crossbar array with weights for a machine learning model using conductance values within the mapped ranges. Machine learning operations (such as matrix-vector multiplications) can then be performed using the programmed memristor crossbar array. The memristor crossbar arrays may inherently exhibit noise due to the stochastic nature of ion migration, device-to-device variations, and non-ideal conductance states in the memristors. The inherent noise of the memristors may provide differential privacy without requiring additional noise generation.

In some implementations, a desired level of privacy may correspond to an input privacy parameter. The desired privacy parameter may be any level of privacy that is desired by the user. In some implementations, the desired privacy parameter may be mapped to corresponding memristor conductance ranges that produce an appropriate level of noise. The conductance ranges may be determined based on the desired level of privacy and the properties of the memristors. The memristor crossbar array may be programmed with weights for a machine learning model using conductance values within the mapped ranges.

Machine learning operations can be performed using the programmed memristor crossbar array wherein the inherent noise of the memristors provides differential privacy substantially without requiring additional noise generation. As an example, the inherent noise of the memristors may be used to provide differential privacy by introducing randomness into the machine learning operations. The amount of noise introduced may be controlled by adjusting the conductance values of the memristors. The resulting machine learning model may be relatively accurate and provide acceptable privacy protection.

In some implementations, the system may provide increased computational speed and reduced power consumption. In some aspects, differential privacy objectives may be achieved using the inherent characteristics of the crossbar array components and utilizing empirical data of the relationship between programmed conductance (e.g., intended conductance values selected for programming to a memristor) and the variability of read values (e.g., actual conductance values that vary from the intended conductance value being programmed). As an example, programming conductance values at a relatively higher order of magnitude may result in actual programmed conductance values that have a certain level of variability, while programming conductance values at a relatively smaller order of magnitude may result in actual programmed conductance values that have a relatively greater level of variability. In some examples, the level of variability of the actual programmed conductance values corresponds to the amount of noise introduced by using crossbar arrays that include memristors programmed with such actual conductance values. Thus, in some examples, selecting the order of magnitude of the conductance values to be programmed has the effect of selecting the amount of variability of the actual conductance values, and thus the inherent noise that is introduced. The system and method can be applied at multiple stages of the machine learning pipeline and can substantially prevent or reduce, e.g., overfitting, and improve the generalization performance of the machine learning model.

In one implementation, the system controls the introduction of noise via selection of conductance value ranges of programmed memristors in the crossbar array. Such noise may then be added to the gradients during backpropagation via the variability of the conductance of memristors in crossbar arrays used during the execution of a machine learning algorithm, which may, for example, reduce overfitting and improve generalization performance of the machine learning model. In another implementation, the system adds noise to the training data or model outputs, which can reduce memorizing, by the machine learning model, of the training data and improves its ability of the machine learning model to generalize to new data. In some implementations, the noise selection component may select the electrical property (e.g., conductance) range to reduce noise while maintaining a level of privacy specified by the privacy parameter.

In some implementations, the system may balance the demands of computational performance, energy efficiency, and privacy protection for machine learning and data analysis. In some implementations, the system may include the following advantages: efficient noise introduction without substantial latency overhead as well as using inherent physical noise in addition to or instead of noise emulation. This allows differential privacy to be implemented on memristor-based machine learning accelerators with a reduced impact on performance or energy efficiency. The system and method can be implemented in various machine learning frameworks and can be integrated into existing pipelines for training and/or executing machine learning algorithms.

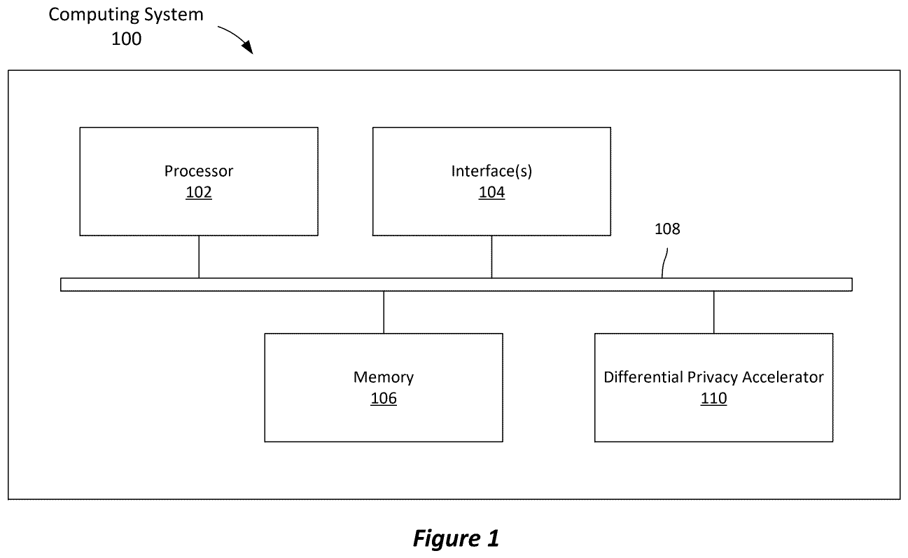

FIG. 1 illustrates an example computing system 100, according to some implementations. More specifically, FIG. 1 depicts a computing system 100 that may be configured, for example, to accelerate machine learning operations, such as neural network computations. To achieve its desired functionality, the computing system 100 includes various hardware components. In some implementations, the computing system 100 includes a processor 102, interface(s) 104, a memory 106, and a bus 108 that facilitates communication between such components. The computing system 100 may also include an differential privacy accelerator 110, which may be coupled to the bus 108.

The computing system 100 may be implemented in an electronic device. Examples of electronic devices include servers, desktop computers, laptop computers, mobile devices, gaming systems, and the like. The computing system 100 may be utilized in any data processing scenario, including, for example, stand-alone hardware, mobile applications, or combinations thereof. Further, the computing system 100 may be used in a computing network, such as a public cloud network, a private cloud network, a hybrid cloud network, other forms of networks, or combinations thereof. In one example, the methods provided by the computing system 100 are provided as a service over a network by, for example, a third party. The computing system 100 may be implemented on one or more hardware platforms, in which the modules in the system can be executed on one or more platforms. Such modules can run on various forms of cloud technologies and hybrid cloud technologies or be offered as a Software-as-a-Service that can be implemented on or off a cloud.

In some implementations, the processor 102 retrieves executable code from the memory 106 and executes the executable code. The executable code may, when executed by the processor 102, cause the processor 102 to implement all or any portion of the functionality described herein. The processor 102 may be a microprocessor, an application-specific integrated circuit, a microcontroller, or the like.

In some implementations, the interface(s) 104 allow the processor 102 to interface with various other hardware elements, external and internal to the computing system 100. For example, the interface(s) 104 may include interface(s) to input/output devices, such as, for example, a display device, a mouse, a keyboard, etc. The interface(s) 104 may include interface(s) to an external storage device, or to a number of network devices, such as servers, switches, and routers, client devices, other types of computing devices, and combinations thereof.

The memory 106 may include various types of memory modules, including volatile and nonvolatile memory. For example, the memory 106 may include Random Access Memory (RAM), Read Only Memory (ROM), a Hard Disk Drive (HDD), a Solid State Drive (SSD), or the like. The memory 106 may include a non-transitory computer readable medium that stores instructions for execution by the processor 102. One or more modules within the computing system 100 may be partially or wholly embodied as software and/or hardware for performing any functionality described herein. Different types of memory may be used for different data storage needs. For example, in certain examples the processor 102 may boot from ROM, maintain nonvolatile storage in an HDD, and execute program code stored in RAM.

The interface 104 may allow the computing system 100 to communicate with external devices or networks, thereby allowing input of data for processing and output of results. The processor 102 executes instructions and coordinates the overall operation of the system, including interactions with the differential privacy accelerator 110.

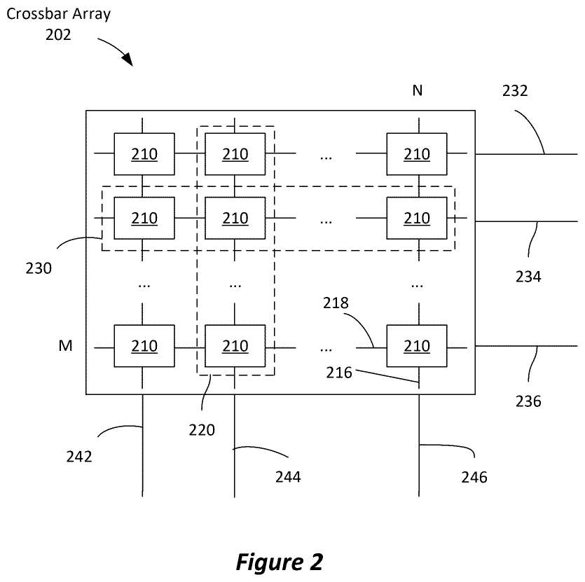

An overview of the differential privacy accelerator 110 is described in FIG. 1. A more detailed view of the internal components and structure that may be included in the differential privacy accelerator 110 is described in FIGS. 2-4 below.

As an example, the differential privacy accelerator 110 may include a crossbar array (e.g., a dot product engine), which is described in FIG. 2 below. In some implementations, the crossbar array includes a plurality of input electrodes, a plurality of output electrodes, and a plurality of cells (e.g., programmable elements). The crossbar array also may be referred to as a programmable crossbar array. In some examples, the programmable elements of the crossbar array are implemented, at least in part, using memristors. In some examples, such a crossbar array may be used for performing various operations as part of executing machine learning operations, such as, for example, matrix-vector multiplications (e.g., multiplication of an input vector by a matrix stored in the crossbar array via conductance values programmed to the memristors therein).

In some implementations, for forward propagation of neural network operations, the input electrodes are arranged in crossbar rows (e.g., a crossbar row 230), the output electrodes are arranged in crossbar columns (e.g., a crossbar column 220).

In some implementations, for backward propagation of neural network operations, the output electrodes are arranged in the crossbar rows (e.g., the crossbar row 230), the input electrodes are arranged in the crossbar columns (e.g., the crossbar column 220).

Each cell can be positioned at a crosspoint or junction of an input electrode and an output electrode. As input, the crossbar array can take a vector of signals (on the input electrodes).

In some implementations, for neural network acceleration, the differential privacy accelerator 110 may be utilized for efficient matrix-vector multiplications and/or other operations for the neural network computations.

In some aspects, the differential privacy accelerator 110 is configured to perform differential privacy operations efficiently. This may involve using the inherent noise characteristics of memristor crossbar arrays.

In some cases, the differential privacy accelerator 110 may include a crossbar array and a noise selection component. The crossbar array may be used to perform computations, which may exhibit inherent variability, and thus noise, based on the variability of the actual conductance values of the memristors of the crossbar array relative to the conductance values that were intended to be programmed to the memristors. The noise selection component may be configured to control the noise characteristics of the crossbar array based on a received privacy parameter. This allows the differential privacy accelerator 110 to introduce controlled noise into the computations, thereby implementing differential privacy techniques.

In some aspects, the computing system 100 may be configured to perform machine learning (ML) operations using the differential privacy accelerator 110. This may involve training an ML model using data (e.g., stored in the memory 106), with the differential privacy accelerator 110 introducing noise into the computations (e.g., via memristor cross bar arrays) to implement differential privacy. The level of noise introduced may be controlled based on a privacy parameter received by the computing system 100, which is correlated to a particular memristor conductance value range, allowing the computing system 100 to balance the trade-off between privacy protection and the utility of the ML model.

FIG. 2 illustrates an example crossbar array 202, according to some implementations. In some examples, the crossbar array 202 may be a component of a differential privacy accelerator (e.g., the differential privacy accelerator 110 of FIG. 1), which may be configured to perform, for example, matrix-vector operations for forward and backward propagation in neural networks.

The crossbar array 202 comprises multiple cells 210 arranged in a grid-like structure of rows 230 and columns 220. Each cell 210 represents a cell in the crossbar array 202 and may include one or more memristors that can be programmed to have a specific conductance value, which can be used, for example, to represent weights in an ML model. In such an example, the conductance values programmed to the memristors of the cells may thus correspond to a matrix of weights.

In some implementations, the crossbar array 202 may be programmed with the weights of a pre-trained neural network. When input data is provided to the computing system 100, the crossbar array 202 can relatively rapidly perform matrix-vector multiplications by applying a vector representing the input data to the crossbar array 202 to multiply the input vector by the weight matrix stored in the crossbar array 202, thereby accelerating the forward pass of the neural network.

In some implementations, the differential privacy accelerator 110 can be utilized to accelerate forward pass computations. As an example, after each forward pass, the processor 102 may calculate the gradients and update the weights stored in the crossbar array 202 by reprogramming the conductance values of memristors of the crossbar array 202. The bus 108 between the memory 106 and the processor 102 allows transfer of training data and intermediate results.

In some implementations, the crossbar array 202 may include cells (e.g., programmable elements). In some implementations, the cells may be circuit elements that may have electrical properties.

Electrical properties may be adjustable parameters of various analog hardware components (e.g., memristors) included in the cells 210 that may be utilized for implementing differential privacy techniques. An electrical property range may be a range of values that may be programmed to components of the cells 210, and that can be adjusted to control noise levels in the analog hardware components (e.g., the cells 210) via inherent variability of the actual values present after programming. The electrical property range may include conductance range, resistance range, capacitance range, inductance range, impedance range, transconductance range, current range, voltage range, charge storage range, magnetic flux range, and/or other suitable ranges of electrical properties.

The cells may be non-volatile analog devices, which may be adapted to store one or more bits of data. An example of a cell is a memristor, which includes a dielectric layer (e.g., an oxide layer) between two metal layers. When the cells are memristors, the crossbar array 202 is a memristor crossbar array. Other examples of cells include multi-bit flash memory cells, ReRAM cells, PCRAM cells, MRAM cells, ECRAM cells, and/or other suitable cells. As an example, when the crossbar array 202 is a memristor crossbar array, after programming a conductance value to a memristor, multiple reads of the conductance value of the memristor may result in different conductance values being read. In one or more examples, the standard deviation of the read conductance values grows (e.g., relatively linearly) as the order of magnitude of the programmed conductance value decreases. Thus, in one or more examples, by tuning the conductance value to be programmed to a memristor, it is possible to tune the standard deviation of the conductance values read from the memristor. In one or more examples, this tunable variation of conductance values may be considered as noise.

The crossbar array 202 may also include other peripheral circuitries associated with the crossbar array 202. For example, the crossbar array 202 may include drivers connected to the input electrodes. An address decoder can be used to select an input electrode and activate a driver corresponding to the selected input electrode. The driver for a selected input electrode can drive a corresponding input electrode with different voltages corresponding to a matrix-vector multiplication or the process of setting a range of electrical properties within the cells of the crossbar array 202. Similar driver and decoder circuitry may be included for the output electrodes.

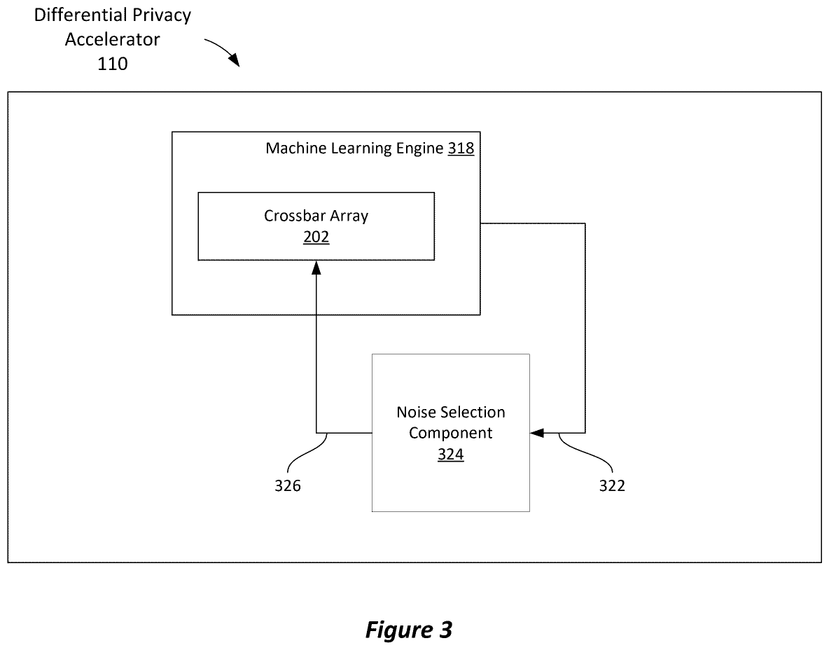

Control circuitry, e.g., a noise selection component (e.g., the noise selection component 324 in FIG. 3, which is discussed further below) may also be used to control application of voltages at the inputs of the crossbar array 202 in order to program the elements of the crossbar array. Input signals to the input electrodes and the output electrodes can be analog signals. The peripheral circuitry can be fabricated using semiconductor processing techniques in the same integrated structure or semiconductor die as the crossbar array 202.

In some implementations, the crossbar array 202 can include Z input electrodes and U output electrodes. As described in further detail below, there are at least two operations that occur during operation of the crossbar array 202. The first operation is to program the cells in the crossbar array 202 so as to map the mathematic values in a Z×U matrix to the cells for crossbar array 202. The second operation is the dot product or matrix-vector multiplication operation. In this operation, input voltages are applied to the input electrodes and output currents are obtained from the output electrodes, corresponding to the result of multiplying a Z×1 vector with the Z×U matrices. The input voltages are below the threshold of the programming voltage of the cells so the programmed values of the cells in the crossbar array 202 are not changed during the matrix-vector multiplication operation.

As an example, in implementations where the crossbar array 202 uses memristors as cells, the following programming process may be used. The crossbar array 202 may be programmed to store a Z×U matrix by modifying the conductances of memristors of the cells. In some implementations, the conductances of memristors of the cells are values corresponding to the Z×U matrix. The conductances of the memristors may be modified by imposing a voltage across the cells using the input electrodes, the output electrodes, and corresponding voltage drivers. In some implementations, the voltage difference imposed across a cell generally determines the resulting conductance of memristors of that cell. The programming process may be performed row-by-row.

A matrix-vector multiplication may be executed, as an example, through the crossbar array 202 by applying a set of voltages (e.g., an input vector of voltage values) simultaneously along the input electrodes of the crossbar array 202 and collecting the currents through the output electrodes. The signal generated on an output electrode is weighted by the corresponding conductance of the cells at the crosspoints of the output electrode with the input electrodes, and that weighted summation is reflected in the current at the output electrode. Thus, the relationship between the voltages at the input electrodes and the currents at the output electrodes is represented by a matrix-vector multiplication of the input vector with the Z×U matrix determined by the conductances of the cells for crossbar array 202.

The memristor crossbar array 202 can be implemented in various architectures, including one transistor, one memristor (1T1M), 2T2M configurations, and self-rectifying crossbar architectures. In some implementations, the 1T1M configuration may have an architecture, where each memristor is coupled to a single transistor, which functions as a switch to control the flow of current through the memristor.

In the 2T2M configuration, each memristor may be coupled to two transistors, which allows for a higher density of memristors to be coupled to a single circuit. The 2T2M architecture may offer high scalability and performance. In the self-rectifying crossbar architecture, the memristors may be arranged in a crossbar pattern, and each memristor may be coupled to two electrodes. The self-rectifying crossbar architecture may allow for bidirectional current flow, which can be used to implement logic functions and other computing operations.

In some aspects, the crossbar array 202 is used to perform a matrix-vector operation using the programmed crossbar array 202 to obtain a result. This operation can be part of the forward propagation process in a neural network, where the input data is multiplied by the weights represented by the conductance values of the cells 210 in the crossbar array 202. The result of this operation is an output vector that represents the output of a layer in the neural network.

In some cases, the crossbar array 202 is also used to compute gradients based on the output of the forward propagation process. This computation is part of the backward propagation process in a neural network, where the error in the output is used to adjust the weights in the network. The gradients represent the rate of change of the error with respect to the weights, and they are used to update the weights in the direction that minimizes the error.

The crossbar array 202 inherently introduces noise due to the stochastic nature of the cells 210 (e.g., based on the inherent variability of conductance values of memristors). This noise can be used to implement differential privacy techniques. In some aspects, the noise is introduced during the gradient computation process. The noise can be controlled by selecting an appropriate electrical property range for the cells 210 based on a privacy parameter. This allows the crossbar array 202 to balance the trade-off between privacy protection and the utility of the ML model.

In some implementations, the differential privacy accelerator 110 may adjust the selected electrical property range based on a desired trade-off between privacy protection and computational accuracy. A noise selection component (e.g., the noise selection component 324 in FIG. 3) may be configured to fine-tune the electrical property range of the crossbar array 202 to balance the level of privacy protection with the accuracy of the computations performed by the differential privacy accelerator 110. This adjustment allows the computing system 100 to be optimized for different use cases where either privacy or accuracy may be prioritized.

In some implementations, the crossbar array 202 is a memristor crossbar array. The electrical property range in this case comprises a range of memristor conductance values. The conductance of each memristor in the array can be programmed to a specific value within this range, which results in an actual conductance value of the memristor that has a certain level of standard deviation, thereby allowing control over the noise characteristics of the crossbar array 202.

In some cases, the crossbar array 202 is also used to add noise when reading training data or model outputs. The noise can be introduced by programming the cells 210 with conductance values that produce a desired level of noise. This allows the crossbar array 202 to protect the privacy of the training data or model outputs without requiring additional noise generation mechanisms.

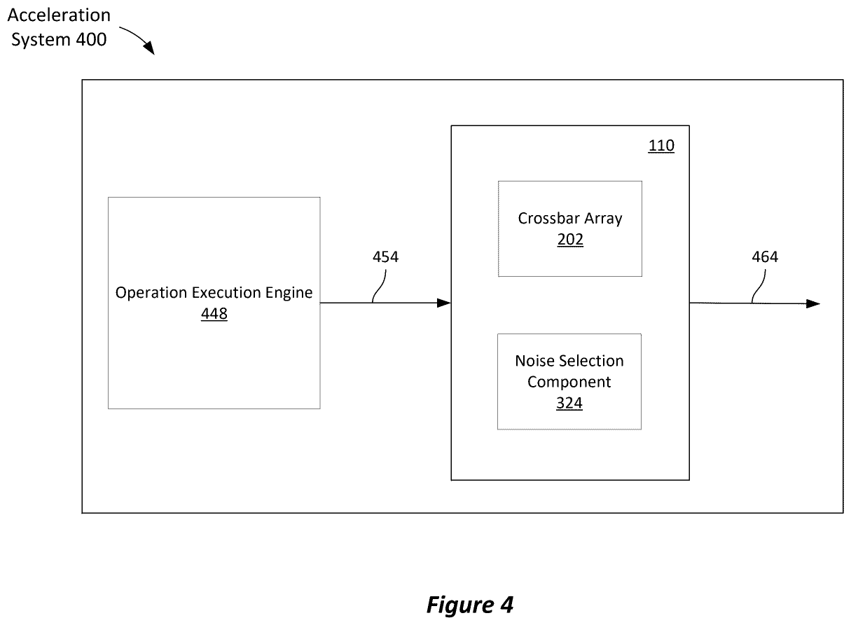

In some aspects, the crossbar array 202 may be operatively connected to a noise selection component (e.g., the noise selection component 324 in FIG. 3) that manages the noise characteristics of the crossbar array 202. The noise selection component may adjust the electrical property range used to program the cells 210 based on a received privacy parameter, thereby controlling the level of noise introduced during the gradient computation and data reading processes. The noise selection component is discussed further, below, in the descriptions of FIG. 3 and FIG. 4.

In some implementations, the conductance of memristors in a crossbar array 202 can be programmed across several orders of magnitude, (e.g., from approximately 10⁻¹⁰ to 10⁻³ Siemens). In some implementations, the noise characteristics (e.g., standard deviation of conductance values) vary across this range, providing a tunable parameter for implementing privacy-preserving computations.

In some implementations, for a given programmed conductance value, a read of the actual conductance value after programming may exhibit a variability (e.g., standard deviation) that corresponds to the order of magnitude of the conductance value being programmed. As an example, conductance values of a relatively high order of magnitude (e.g., 10⁻³) may remain relatively stable (e.g., have a relatively low standard deviation) over multiple read operations, while conductance values at a lower order of magnitude (e.g., 10⁻¹⁰) may vary more over multiple read operations (e.g., have a relatively high standard deviation). Thus, selecting to program conductance values at a particular order of magnitude allows for selection of the standard deviation of the actual conductance values (e.g., the inherent noise), which may be used to implement desired privacy levels in ML operations.

In some implementations, as discussed above, the probability distribution of conductance readings varies depending on the programmed conductance level. This variability in distribution can be exploited to achieve different levels of differential privacy.

In some implementations, there may be an established relationship between the mean conductance and the standard deviation of conductance. This relationship may be used for selecting appropriate conductance ranges to achieve desired privacy levels while maintaining computational accuracy.

In some implementations, the coefficient of variation provides insight into the relative variability of conductance readings across different conductance levels. This metric can be used to fine-tune the trade-off between privacy and utility (e.g., in the differential privacy accelerator 110 of FIG. 1).

In some implementations, a range of conductance values, particularly between 10⁻⁹ and 10⁻⁵ Siemens, may be suitable for implementing differential privacy. This range offers a good balance between controllable noise levels and stable readings.

In some implementations, the relationships between conductance, noise, and variability allow the implementation of adaptive privacy settings. By dynamically adjusting the programmed conductance values, the system can potentially modify privacy levels in real-time based on computational requirements or changing privacy needs.

In some aspects, the inherent noise characteristics of the memristor crossbar array 202 may be observed through multiple conductance readings. When a conductance value is read repeatedly after programming, variations in the readings may occur, which may range from 0.1% to 5% of the programmed value, indicating the presence of intrinsic noise in the system.

The standard deviation of conductance measurements may exhibit a linear increase for conductance values between 0.1 nS and 10 μS, potentially reaching a saturation point at conductance levels above 10 μS. This behavior may allow for tuning of the standard deviation by adjusting the programmed conductance values within the 0.1 nS-10 μS range.

In some cases, the coefficient of variation of conductance readings may provide additional insights into the noise characteristics of the memristor crossbar array 202. This metric may offer a normalized measure of variability across different conductance ranges, which may fall between 0.01 and 0.1 for conductance values from 1 μS to 50 μS.

The observed variability in conductance readings and the relationship between conductance levels and standard deviation may be used for implementing differential privacy techniques. In some implementations, the ability to tune the standard deviation by adjusting conductance values within the 0.1 nS-10 μS range may provide a mechanism for controlling the level of noise introduced into computations, with noise levels potentially varying from 0.1 nA to 100 nA. As an example, when an input voltage of 0.1 volts is applied, and the conductance has a maximum standard deviation of 1 microsiemens, the resulting output current may have a maximum noise level of 100 nanoamperes because current equals voltage multiplied by conductance, according to some implementations.

The inherent noise characteristics disclosed herein may be advantageously utilized to achieve privacy-preserving computations, potentially allowing for privacy parameter having epsilon values ranging from 0.1 to 10. Thus, in some implementations, a desired privacy level may be indicated via receipt of a value of such a privacy parameter, which may, in turn, be correlated to a conductance value range that, when used, results in the desired privacy level achieved through the inherent variability of conductance values when that conductance value range is used for conductance programming.

While certain implementations may utilize epsilon values in the range of 0.1 to 10 for the privacy parameter, it should be understood that the epsilon values are not limited to this specific range. As an example, the epsilon value may start from zero (0), which may provide the strongest privacy level; the epsilon value substantially may not have a predetermined upper limit. In some implementations, the appropriate epsilon value may be selected based on the specific application requirements, desired privacy levels, and acceptable utility trade-offs for a given use case. Higher epsilon values may provide weaker privacy levels but potentially better utility, while lower epsilon values provide stronger privacy levels but may affect utility more significantly. The selection of epsilon values can be dynamically adjusted based on factors such as data sensitivity, regulatory requirements, application context, and the specific privacy-utility balance needed for a particular implementation.

FIG. 3 illustrates an example differential privacy accelerator 110, according to some implementations. More specifically, the ML engine 318 and the noise selection component 324 are depicted as additional components of the differential privacy accelerator 110 of a computing system (e.g., the computing system 100 of FIG. 1) configured, in conjunction with the crossbar array 202, to implement differential privacy in ML operations. The ML engine 318 may include the crossbar array 202. The crossbar array 202 may be communicatively coupled to peripherals of the ML engine 318. The peripherals of the ML engine 318 may perform various machine learning operations. The ML engine 318 may be communicatively coupled to the noise selection component 324 such that a feedback signal 322 is transmitted from the ML engine 318 to the noise selection component 324. In some implementations, the feedback signal 322 allows the ML engine 318 to provide information to the noise selection component 324, potentially for adjusting noise parameters.

In some aspects, the ML engine 318 may receive training data for an ML model. As an example, this training data may be stored in the memory 106 of the computing system 100 of FIG. 1, and may be used to train an ML model using the differential privacy accelerator 110. The training data may include various types of data, such as images, text, audio, video, or any other types of data that can be used to train an ML model.

The ML engine 318 may also compute gradients based on the output of the forward propagation process. Such computation is part of the backward propagation process in a neural network, where the error in the output is used to adjust the weights in the neural network.

As an example, the gradient computation may be performed using the same crossbar array 202 that is used for forward propagation, but operated in a transposed manner for backward propagation. The crossbar array 202 may perform matrix transpose-vector multiplications to efficiently calculate the gradients.

The gradients represent the rate of change of the error with respect to the weights, and they are used to update the weights in the direction that minimizes the error. These gradients indicate the direction and magnitude of weight adjustments appropriate for reduction of the error.

In some cases, the ML engine 318 may adjust the computed gradients based, at least in part, on a privacy parameter. This adjustment process may involve selecting noise to be applied to the gradients or modifying the noise values to improve privacy protection while maintaining the utility of the ML model, which may be achieved, for example, by selecting the range of conductance values of memristors of the crossbar array 202. The adjusted gradients may then be used to update the ML model, potentially improving its performance or accuracy over time.

In some examples, the privacy parameter may correspond to an epsilon value in a differential privacy model. In some implementations, epsilon may be a measure of the strength of the privacy level in differential privacy. In some implementations, the epsilon value may be referred to as the “privacy budget” or “privacy loss parameter.”

In some implementations, the value of epsilon may range between 0 and some positive number, e.g., between 0 and 1, for example, the privacy budget may be 0.8. In some implementations, lower epsilon values indicate stronger privacy levels but potentially less accurate or useful results. Higher epsilon values may provide weaker privacy levels but potentially more accurate or useful results.

In some implementations, the epsilon value may inform an appropriate level of noise to be introduced via the selection (e.g., by the noise selection component 324) of appropriate conductance ranges for the memristors (e.g., cells 210) of the crossbar array 202. In some implementations, the selection of a particular epsilon value as a privacy parameter may balance the trade-off between privacy protection and utility of the data or computation results.

In some implementations, the noise selection component 324 may translate the epsilon value (or another representation of the desired privacy level as a privacy parameter) into specific conductance ranges to be programmed to the memristors, thereby implementing the differential privacy mechanism in hardware (e.g., the crossbar array 202).

As an example, the noise selection component 324 may use a received epsilon value (e.g., a privacy parameter) to determine the appropriate level of noise to select during the gradient computation and model updating processes. This approach may allow the differential privacy accelerator 110 to achieve the desired level of differential privacy while maximizing the utility of the ML model and the efficiency of the training process.

The differential privacy accelerator 110 may be configured to determine a noise level for the matrix-vector operation based on the privacy parameter. Once this noise level is determined, the electrical property range of the crossbar array 202 can be adjusted to achieve the determined noise level. This process allows control over the amount of noise introduced into the computations, allowing the privacy levels specified by the privacy parameter to be met while maintaining performance of the differential privacy accelerator 110.

In some implementations, adjusting the gradients based on the privacy parameter comprises introducing noise to the computed gradients. The amount of noise introduced may be determined based on the privacy parameter. This process allows for the implementation of differential privacy in the gradient computation stage of ML model training, providing privacy levels for the training data.

In some implementations, the differential privacy accelerator 110 may dynamically adjust noise level (e.g., via the noise selection component 324) during training of the ML model based, at least in part, on a convergence rate of the model. This dynamic adjustment may allow the differential privacy accelerator 110 to balance privacy protection with model performance, potentially relaxing privacy constraints as the model converges to improve final model accuracy.

In some aspects, the differential privacy accelerator 110 may monitor the convergence rate of the model during training. As an example, the convergence rate may be measured by tracking changes in the model loss function or accuracy metrics over training iterations.

As the model begins to converge, the differential privacy accelerator 110 may gradually relax the privacy constraints. As an example, the relaxation may involve increasing the epsilon value of the differential privacy mechanism, which may allow for less privacy, but potentially improving model accuracy.

In some implementations, the differential privacy accelerator 110 may adjust the noise selected for the gradients or model outputs, potentially reducing the amount of noise selected as training progresses. In some implementations, the differential privacy accelerator 110 may modify the clipping threshold for gradients, possibly allowing for larger gradient updates in later stages of training.

In some implementations, the differential privacy accelerator 110 may adapt the sampling rate or batch size used in training, which may affect the trade-off between privacy and utility. The relaxation process may be implemented using various approaches: linear relaxation, adaptive relaxation, and/or step-wise relaxation.

In some implementations, the privacy parameter may be adjusted linearly over time or training epochs. In some implementations, the rate of relaxation may be based on the model performance, potentially slowing down when the model shows substantial accuracy gains. In some implementations, the privacy parameter may be adjusted in discrete steps at predetermined points in the training process.

In some implementations, the differential privacy accelerator 110 may employ a multi-objective optimization approach, balancing privacy protection and model performance. This approach may involve defining a composite objective function that considers both privacy loss and model accuracy. The accelerator may also implement safeguards to allow the privacy relaxation not to exceed predefined limits, maintaining a minimum level of privacy protection throughout the training process.

In some cases, the noise selection component 324 may be configured to calibrate the noise selection process to increase the ML model accuracy while satisfying a privacy level specified by the privacy parameter. In some implementations, the noise selection component 324 may send an input signal 326 to the crossbar array 202 to adjust the noise characteristics. As an example, this calibration process may involve adjusting the noise characteristics of the crossbar array 202 by controlling the conductance value range programmed to memristors to achieve an optimal balance between privacy protection and data utility.

In some cases, the crossbar array 202 may be used to store an output of an operation in the programmed crossbar array 202, where the stored output includes noise based on the programmed electrical property range. This allows the crossbar array 202 to protect the privacy of the training data or model outputs without requiring additional noise generation techniques. The stored output may be used for further processing or analysis, or it may be transmitted to other components of the computing system 100 or to external devices or networks via the interface 104.

Referring to FIG. 4, an example acceleration system 400 is illustrated, according to some implementations. In some implementations, acceleration system 400 may be used for implementing differential privacy. In some implementations, the acceleration system 400 includes an operation execution engine 448 and a differential privacy accelerator 110. In some implementations, the operation execution engine 448 is communicatively coupled to the differential privacy accelerator 110 such that an input signal 454 is transmitted from the operation execution engine 448 to the differential privacy accelerator 110. This coupling allows the operation execution engine 448 to send data or instructions to the differential privacy accelerator 110 for processing. In some implementations, all or any portion of the operation execution engine 448, or the acceleration system 400, may be implemented using a computing system (e.g., the computing system 100 of FIG. 1).

The differential privacy accelerator 110 includes a crossbar array 202 and a noise selection component 324. The crossbar array 202 is used to perform computations and/or store data, while the noise selection component 324 is configured to control the noise characteristics of the crossbar array 202 based on a received privacy parameter. This allows the differential privacy accelerator 110 (e.g., via the noise selection component 324) to select and introduce controlled noise into the computations, thereby implementing differential privacy techniques.

In some aspects, the operation execution engine 448 may send data to the differential privacy accelerator 110 via the input signal 454. This data may include training data for an ML model, model parameters, or other types of data that are used in the ML operations. The differential privacy accelerator 110 processes this data using the crossbar array 202, introducing noise based on the settings determined by the noise selection component 324.

The processed data, which now includes added noise for differential privacy, may be then sent out of the differential privacy accelerator 110 via an output signal 464. This output signal 464 may be directed to other components of the acceleration system 400 or to external devices or networks for further processing or analysis.

In some cases, the operation execution engine 448 may also receive the output signal 464 from the differential privacy accelerator 110. This allows the operation execution engine 448 to use the processed data, which includes the added noise, in further computations or operations. For example, the operation execution engine 448 may use the processed data to update an ML model, perform additional computations, or generate outputs for a user or another system.

In some implementations, the operation execution engine 448 may be external to the acceleration system 400. The acceleration system 400 may receive input data and instructions from an external source, which could be a separate computing system, a cloud-based service, or a distributed network of processors. In such cases, the acceleration system 400 may include the differential privacy accelerator 110 and associated components, providing computations and noise selection for differential privacy.

The input signal 454 may originate from an external source, bypassing the operation execution engine 448. Similarly, the output signal 464 may be sent to external systems or services for further processing or analysis. In some implementations, the acceleration system 400 may be integrated into various computational architectures (e.g., the computing system 100 of FIG. 1) while main implementing differential privacy techniques using memristor crossbar arrays 202.

In some implementations, the noise selection component 324 may be configured to dynamically adjust the electrical property range during operation of the acceleration system 400 based on changes in a desired privacy level (e.g., changes to a received privacy parameter). This dynamic adjustment capability allows the acceleration system 400 to respond to changing privacy requirements in real-time or near real-time, ensuring that the appropriate level of differential privacy is maintained throughout the operation of the acceleration system 400.

The acceleration system 400 may further comprise an ML engine 318 (not shown in FIG. 4) configured to train an ML model using outputs from the crossbar array 202. The inherent noise in these outputs, controlled by the noise selection component 324, may provide differential privacy to the training process. Such an approach may allow for the training of privacy-preserving ML models without the need for additional noise selection/introduction techniques.

In some aspects, the crossbar array 202 is configured to perform computations used in both forward propagation and backward propagation operations for a neural network. The noise selection component 324 may be configured to adjust the electrical property range differently for forward and backward operations based on a received privacy parameter (e.g., an epsilon value). This adjustment may allow for improved noise selection at different stages of a neural network computation, potentially providing stronger privacy levels for relatively sensitive operations like gradient computation during backpropagation.

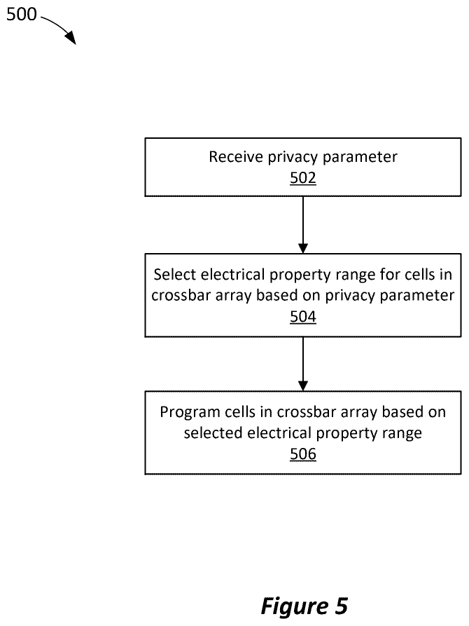

FIG. 5 illustrates an example acceleration method 500, according to some implementations. In some implementations, one or more process blocks of FIG. 5 may be performed by the computing system 100 of FIG. 1, the crossbar array 202 of FIG. 2 and/or FIG. 3, the differential privacy accelerator 110 of FIG. 1, FIG. 2, or FIG. 3, and/or the acceleration system 400 of FIG. 4.

As an example, the method 500 may be used for implementing differential privacy using a crossbar array (e.g., the crossbar array 202 of FIGS. 2-4). In some implementations, the method 500 begins with step 502, which includes receiving a privacy parameter. As an example, the privacy parameter may be provided by a user or another system component, and may represent a desired level of privacy protection for the data or computations (e.g., to be performed by the differential privacy accelerator 110). The privacy parameter may correspond, as an example, to an epsilon value in a differential privacy model, with lower values indicating stronger privacy levels and higher values indicating weaker privacy levels.

Following step 502, the method 500 proceeds to step 504. In this step, an electrical property range for components (e.g., memristors included in the cells 210 of FIG. 2) in a crossbar array (e.g., the crossbar array 202) is selected based on the privacy parameter received in step 502. The electrical property range may include a conductance range, a resistance range, a capacitance range, or other electrical properties that can be adjusted to control the noise characteristics of the cells in the crossbar array 202. As an example, the selection of the electrical property range may involve determining an order of magnitude for the electrical property range based on the privacy parameter, thereby establishing a correlation between the desired privacy level and the physical characteristics of the crossbar array 202.

In some aspects, the privacy parameter received by the computing system 100 or the acceleration system 400 may be used to determine an order of magnitude for the electrical property range based on the privacy parameter. This order of magnitude may correspond to a specific range of conductance values for the cells 210 in the crossbar array 202. The selection of this conductance range may be based, at least partially, on the desired level of privacy protection, with lower conductance values corresponding to stronger privacy levels and higher conductance values corresponding to weaker privacy levels.

In some cases, the noise selection component 324 may be configured to select the conductance range in a way that reduces the computational overhead associated with noise generation. This technique may involve selecting a conductance range that allows the crossbar array 202 to select noise without requiring additional computational resources or causing substantial latency overhead. This noise selection may be achieved by using the inherent physical noise characteristics of the memristor crossbar array 202, instead of or in addition to software-based noise emulation techniques.

In some aspects, the noise selection component 324 may adjust the noise characteristics of the crossbar array 202 based on the privacy parameter. This adjustment process may involve selecting an appropriate electrical property range for the cells 210 in the crossbar array 202, programming the cells 210 based on the selected electrical property range, and controlling the level of noise introduced during the computations. This allows the acceleration system 400 to achieve the desired level of differential privacy while improving the utility of the ML model and the efficiency of the computations.

The next step in the method 500 is step 506. Step 206 may include programming cells in a crossbar array based on the electrical property ranges selected in step 504. As an example, in step 506, the cells 210 in the crossbar array 202 may be programmed based on the selected electrical property range. This programming configures the cells 210 in the crossbar array 202 to operate using programmed values within the specified electrical property range, thereby selecting a controlled level of noise for the computations performed by the crossbar array 202. The noise selected (e.g., by the noise selection component 324) to be programmed to components of the cells 210 can be used to implement differential privacy techniques, thereby providing a privacy level that is relatively proportional to the privacy parameter received in step 502.

In some aspects, although not shown in FIG. 5, the method 500 may further include performing a matrix-vector operation using a programmed crossbar array (e.g., the crossbar array 202) to obtain a result. As an example, such an operation may be part of an ML model training process, where the input data, represented as a vector of values, is multiplied by the weights represented by the conductance values of the programmed cells 210 in the crossbar array 202. The inherent noise of the programmed cells 210 provides differential privacy without requiring additional noise generation, which may improve the efficiency of the ML model training process.

In some cases, although not shown in FIG. 5, the method 500 may include storing an output of an operation in the programmed crossbar array 202, wherein the stored output includes noise based on the programmed electrical property range. This allows the crossbar array 202 to protect the privacy of the training data or model outputs without requiring additional noise generation techniques. The stored output may be used for further processing or analysis, or it may be transmitted to other components of the computing system 100, the acceleration system 400 and/or to external devices or networks for further processing or analysis.

Although FIG. 5 shows example blocks of the acceleration method 500, in some implementations, the method 500 may include additional blocks, fewer blocks, different blocks, or differently arranged blocks than those depicted in FIG. 5. Additionally, or alternatively, two or more of the blocks of method 500 may be performed in parallel.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer-implemented method, comprising:
receiving a privacy parameter;
selecting an electrical property range for cells in a crossbar array based on the privacy parameter; and
programming the cells in the crossbar array based on the selected electrical property range.

2. The computer-implemented method of claim 1, further comprising:
performing a matrix-vector operation using the programmed crossbar array to obtain a result.

3. The computer-implemented method of claim 1, wherein the electrical property range comprises a conductance range.

4. The computer-implemented method of claim 1, wherein selecting the electrical property range comprises:
determining an order of magnitude for the electrical property range based on the privacy parameter.

5. The computer-implemented method of claim 1, further comprising:
storing an output of an operation in the programmed crossbar array,
wherein the stored output comprises noise based on the programmed electrical property range.

6. The computer-implemented method of claim 1, further comprising:
adjusting the selected electrical property range based on computational accuracy.

7. The computer-implemented method of claim 1, wherein the crossbar array comprises a memristor crossbar array.

8. A computer-implemented method for implementing differential privacy in machine learning, the method comprising:
receiving training data for a machine learning model;
receiving a privacy parameter;
selecting an electrical property range for cells in a crossbar array based on the privacy parameter;
programming the cells in the crossbar array based on the selected electrical property range;
performing a matrix-vector operation using the programmed crossbar array and a portion of the training data to generate an output;
computing gradients based on the output;
adjusting the gradients based on the privacy parameter; and
updating the machine learning model using the adjusted gradients.

9. The computer-implemented method of claim 8, further comprising:
calibrating noise selection to increase machine learning model accuracy while satisfying a privacy level based on the privacy parameter.

10. The computer-implemented method of claim 8, wherein the privacy parameter corresponds to an epsilon value in a differential privacy model.

11. The computer-implemented method of claim 8, further comprising:
determining a noise level for the matrix-vector operation based on the privacy parameter; and
adjusting the electrical property range to select the determined noise level.

12. The computer-implemented method of claim 8, wherein adjusting the gradients based on the privacy parameter comprises:
selecting an amount of noise for the computed gradients,
wherein the amount of noise is determined based on the privacy parameter.

13. The computer-implemented method of claim 8, further comprising:
dynamically adjusting the privacy parameter during training of the machine learning model based on a convergence rate of the machine learning model.

14. A system comprising:
a crossbar array comprising cells; and
a noise selection component configured to:
receive a privacy parameter:
select an electrical property range for the cells based on the privacy parameter, and
program the cells based on the selected electrical property range.

15. The system of claim 14, wherein:
the cells comprise memristors, and
the electrical property range is a conductance range.

16. The system of claim 14, wherein the noise selection component is further configured to:
perform a matrix-vector operation using the programmed crossbar array to obtain a result with noise based on the programmed electrical property range.

17. The system of claim 14, wherein the noise selection component is further configured to:
select the electrical property range to reduce noise while maintaining a level of privacy specified by the privacy parameter.

18. The system of claim 14, wherein the noise selection component is further configured to:
dynamically adjust the electrical property range during operation of the system based on changes in the privacy parameter.

19. The system of claim 14, further comprising:
a machine learning engine configured to train a machine learning model using outputs from the crossbar array, wherein noise in the outputs provides differential privacy to a training process.

20. The system of claim 14, wherein:
the crossbar array is configured to perform a forward propagation operation and a backward propagation operation for a neural network, and
the noise selection component is configured to adjust, based on the privacy parameter, the electrical property range differently for the forward propagation operation and the backward propagation operation.
